(19) United States
(12) Patent Application Publication
(10) Pub. No.: US 2026/0356726 A1
(43) Pub. Date: Nov. 12, 2026

(54) METHODS OF FORMING 3D SHAPED GLASS CERAMICS

(71) Applicant: CORNING INCORPORATED, CORNING, NY (US)

(72) Inventors: Anthony Vincent DeCeanne, Painted Post, NY (US); Jill Marie Edwards, Elmira, NY (US); Jeremy David Hurd, Horseheads, NY (US); Galan Gregory Moore, Henrietta, NY (US); Michael Morgan Oliver, Hammondsport, NY (US); John Robert Saltzer, Jr., Beaver Dams, NY (US); Ljerka Ukrainczyk, Ithaca, NY (US)

(21) Appl. No.: 19/244,304

(22) Filed: Jun. 20, 2025

Related U.S. Application Data
(60) Provisional application No. 63/662,711, filed on Jun. 21, 2024.
(60) Provisional application No. 63/709,046, filed on Oct. 18, 2024.

(51) Int. Cl. C03B 32/02; C03B 11/12

(52) U.S. Cl. CPC C03B 32/02; C03B 11/122

(57) ABSTRACT

A method of forming a 3D shaped glass ceramic comprises nucleating a green glass article to form a nucleated glass article, the green glass article comprising a nucleating agent; sizing the nucleated glass article to form a preform; and molding the preform to shape and to crystallize the preform, thereby forming the 3D shaped glass ceramic.

### CROSS-REFERENCE TO RELATED APPLICATIONS

The present application claims priority to U.S. Provisional Application 63/709,046 filed Oct. 18, 2024 titled “Methods of Forming 3D Shaped Glass Ceramics” and U.S. Provisional Application 63/662,711 filed Jun. 21, 2024 titled “Methods of Forming 3D Shaped Glass Ceramics,” both of which are incorporated by reference herein in their entireties

### FIELD

The present specification generally relates to glass ceramics and, in particular, to methods of forming 3D shaped glass ceramic.

### TECHNICAL BACKGROUND

Shaped glass ceramic articles, such as sheets, can be desirable for use as housings or cover glasses for electronic devices, such as phones and/or tablets, for example. Such shaped glass ceramic substrates can be used to provide features such as a curved or wrap around appearance, a desired opacity and/or color, and/or a desired mechanical and/or optical performance. However, conventional methods of forming 3D shaped glass ceramics may not achieve these desired features.

Therefore, a continuing need exists for alternative methods for forming 3D shaped glass ceramics having desired mechanical and optical properties.

### SUMMARY

According to a first aspect A1, a method of forming a 3D shaped glass ceramic comprises nucleating a green glass article to form a nucleated glass article, the green glass article comprising a nucleating agent; sizing the nucleated glass article to form a preform; and molding the preform to shape and to crystallize the preform, thereby forming the 3D shaped glass ceramic.

A second aspect A2 includes the method of the first aspect A1, wherein the nucleating agent comprises P₂O₅, TiO₂, ZrO₂, or combinations thereof.

A third aspect A3 includes the method of the first aspect A1 or the second aspect A2, wherein the nucleating the green glass article comprises heating the green glass article to a nucleating temperature greater than or equal to 560 °C and less than or equal to 620 °C and holding at the nucleating temperature for a nucleating temperature hold time period greater than or equal to 30 minutes and less than or equal to 360 minutes.

A fourth aspect A4 includes the method of any one of the first through third aspects A1-A3, wherein the molding the preform comprises: applying a pressure to the preform; and heating the preform at a molding temperature.

A fifth aspect A5 includes the method of the fourth aspect A4, wherein the pressure is greater than or equal to 0.5 MPa and less than or equal to 0.9 MPa.

A sixth aspect A6 includes the method of the fourth aspect A4, wherein the pressure is greater than or equal to 0.001 MPa and less than or equal to 1.0 MPa.

A seventh aspect A7 includes the method of any one of the fourth through sixth aspects A4-A6, wherein the molding temperature is greater than or equal to 800 °C and less than or equal to 820 °C.

An eighth aspect A8 includes the method of any one of the fourth through sixth aspects A4-A6, wherein the molding temperature is greater than or equal to 700 °C and less than or equal to 900 °C.

A ninth aspect A9 includes the method of any one of the first through eighth aspects A1-A8, wherein the green glass article comprises a green glass sheet.

A tenth aspect A10 includes the method of any one of the first through ninth aspects A1-A9, wherein further comprising disposing the preform on a mold prior to the molding the preform, wherein the preform is at least partially crystallized during the disposing the preform on the mold.

An eleventh aspect A11 includes the method of any one of the first through tenth aspects A1-A10, wherein the nucleating the green glass article comprises nucleating the green glass article in a furnace.

A twelfth aspect A12 includes the method of any one of the first through eleventh aspects A1-A11, further comprising cooling the 3D shaped glass ceramic.

A thirteenth aspect A13 includes the method of any one of the first through twelfth aspects A1-A12, further comprising: precision finishing the 3D shaped glass ceramic.

A fourteenth aspect A14 includes the method of the thirteenth aspect A13, wherein the precision finishing the 3D shaped glass ceramic comprises at least one of: polishing the 3D shaped glass ceramic; and machining the 3D shaped glass ceramic using a Computer Numerical Control (CNC) machining technique.

According to a fifteenth aspect A15, a method of forming a 3D shaped glass ceramic comprises sizing a green glass article to form a preform having a desired dimension, the green glass article comprising a nucleating agent; and molding the preform to shape and to nucleate the preform, thereby forming a nucleated glass article.

A sixteenth aspect A16 includes the method of the fifteenth aspect A15, wherein during the molding the preform, the preform is at least partially crystallized.

A seventeenth aspect A17 includes the method the fifteenth aspect A15 or the sixteenth aspect A16, further comprising: disposing the nucleated glass article in a furnace to crystallize the nucleated glass article, thereby forming the 3D shaped glass ceramic.

An eighteenth aspect A18 includes the method of the seventeenth aspect A17, wherein the disposing the nucleated glass article in the furnace comprises applying a pressure to the nucleated glass article.

A nineteenth aspect A19 includes the method of the eighteenth aspect A18, wherein the disposing the nucleated glass article in the furnace comprises disposing the nucleated glass article on a mold such that a shape of the 3D shaped glass ceramic is maintained as the pressure is applied.

A twentieth aspect A20 includes the method of any one of the fifteenth through nineteenth aspects A15-A19, wherein the molding the preform comprises applying a pressure to the preform greater than or equal to 0.5 MPa and less than or equal to 0.9 MPa.

A twenty-first aspect A21 includes the method of any one of the fifteenth through nineteenth aspects A15-A19, wherein the molding the preform comprises applying a pressure to the preform greater than or equal to 0.001 MPa and less than or equal to 1.0 MPa.

A twenty-second aspect A22 includes the method of any one of the fifteenth through twenty-first aspects A15-A21, wherein the molding the preform comprises heating the preform to a molding temperature, wherein the molding temperature is less than or equal to 820 °C.

A twenty-third aspect A23 includes the method of any one of the fifteenth through twenty-first aspects A15-A21, wherein the molding the preform comprises heating the preform to a molding temperature, wherein the molding temperature is less than or equal to 900 °C.

A twenty-fourth aspect A24 includes the method of any one of the fifteenth through twenty-third aspects A15-A23, further comprising cooling the 3D shaped glass ceramic.

A twenty-fifth aspect A25 includes the method of any one of the fifteenth through twenty-fourth aspects A15-A24, further comprising precision finishing the 3D shaped glass ceramic.

A twenty-sixth aspect A26 includes the method of the twenty-fifth aspect A25, wherein the step of precision finishing the 3D shaped glass ceramic comprises at least one of: polishing the 3D shaped glass ceramic; and machining the 3D shaped glass ceramic using a Computer Numerical Control (CNC) machining technique.

According to a twenty-seventh aspect A27, a method of forming a 3D shaped glass ceramic comprises sizing a green glass article to form a preform having a desired dimension, the green glass article comprising a nucleating; and molding the preform to shape, to nucleate, and to crystallize the preform, thereby forming the 3D shaped glass ceramic.

A twenty-eighth aspect A28 includes the method of the twenty-seventh aspect A27, wherein the molding the preform comprises applying a pressure greater than or equal to 0.5 MPa and less than or equal to 0.9 MPa to the preform.

A twenty-ninth aspect A29 includes the method of the twenty-seventh aspect A27, wherein the molding the preform comprises applying a pressure greater than or equal to 0.001 MPa and less than or equal to 1.0 MPa to the preform.

A thirtieth aspect A30 includes the method of the twenty-seventh aspect A27, wherein the molding the preform comprises applying a pressure of 0.75 MPa to the preform.

A thirty-first aspect A31 includes the method of any one of the twenty-seventh through thirtieth aspects A27-A30, wherein the molding the preform comprises heating the preform to a molding temperature.

A thirty-second aspect A32 includes the method of the thirty-first aspect A31, wherein the molding temperature is less than or equal to 820 °C.

A thirty-third aspect A33 includes the method of the thirty-first aspect A31, wherein the molding temperature is less than or equal to 900 °C.

A thirty-fourth aspect A34 includes the method of any one of the twenty-seventh through thirty-third aspects A27-A33, further comprising cooling the 3D shaped glass ceramic.

A thirty-fifth aspect A35 includes the method of any one of the twenty-seventh through thirty-fourth aspects A27-A34, further comprising precision finishing the 3D shaped glass ceramic.

A thirty-sixth aspect A36 includes the method of the thirty-fifth aspect A35, wherein the step of precision finishing the 3D shaped glass ceramic comprises at least one of: polishing the desired 3D shape; and machining the 3D shaped glass ceramic using a Computer Numerical Control (CNC) machining technique.

According to a thirty-seventh aspect A37, a nucleated glass sheet, the composition of which, at room temperature, comprises greater than or equal to 55 mol % and less than or equal to 80 mol % SiO₂; greater than or equal to 1 mol % and less than or equal to 14 mol % Al₂O₃; greater than or equal to 10 mol % and less than or equal to 35 mol % Li₂O; greater than or equal to 0 mol % and less than or equal to 12 mol % Na₂O; greater than or equal to 0 mol % and less than or equal to 12 mol % K₂O; greater than or equal to 0 mol % and less than or equal to 12 mol % CaO; greater than or equal to 0 mol % and less than or equal to 15 mol % P₂O₅; greater than or equal to 1 mol % and less than or equal to 15 mol % ZrO₂; greater than or equal to 0 mol % and less than or equal to 15 mol % Fe₂O₃; greater than or equal to 0 mol % and less than or equal to 15 mol % HfO₂; greater than or equal to 0 mol % and less than or equal to 15 mol % SnO₂; greater than or equal to 0 mol % and less than or equal to 10 mol % TiO₂; greater than or equal to 0 mol % and less than or equal to 10 mol % MgO; and a greater amount of lithium metasilicate than lithium disilicate.

A thirty-eighth aspect A38 includes the nucleated glass sheet of the thirty-seventh aspect A38, formed by: nucleating a green glass sheet, the green glass sheet comprising a nucleating agent, the nucleating comprising: heating the green glass sheet to a nucleating temperature greater than or equal to 560 °C and less than or equal to 620° Cat a heating rate greater than or equal to 1 °C/min and less than or equal to 10 °C/min; maintaining the green glass sheet at the nucleating temperature for a time period greater than or equal to 30 minutes and less than or equal to 360 minutes; and cooling the nucleated glass sheet to about room temperature at a cooling rate greater than or equal to 1 °C/min and less than or equal to 5 °C/min.

A thirty-ninth aspect A39 includes the nucleated glass sheet of the thirty-seventh aspect A37 or the thirty-eighth aspect 38, the composition of which, at room temperature, comprises: greater than or equal to 60 mol % and less than or equal to 75 mol % SiO₂; greater than or equal to 1 mol % and less than or equal to 8 mol % Al₂O₃; greater than or equal to 15 mol % and less than or equal to 30 mol % Li₂O; greater than or equal to 0 mol % and less than or equal to 5 mol % Na₂O; greater than or equal to 0 mol % and less than or equal to 5 mol % K₂O; greater than or equal to 0 mol % and less than or equal to 5 mol % CaO; greater than or equal to 0 mol % and less than or equal to 7 mol % P₂O₅; greater than or equal to 1 mol % and less than or equal to 7 mol % ZrO₂; greater than or equal to 0 mol % and less than or equal to 5 mol % Fe₂O₃; greater than or equal to 0 mol % and less than or equal to 5 mol % HfO₂; greater than or equal to 0 mol % and less than or equal to 5 mol % SnO₂; greater than or equal to 0 mol % and less than or equal to 5 mol % TiO₂; and greater than or equal to 0 mol % and less than or equal to 5 mol % MgO.

A fortieth aspect A40 includes a nucleated glass sheet formed by a process comprising: heating a green glass sheet to a nucleating temperature greater than or equal to 560 °C and less than or equal to 620 °C at a heating rate greater than or equal to 1 °C/min and less than or equal to 10 °C/min, the green glass sheet comprising a nucleating agent; maintaining the green glass sheet at the nucleating temperature for a time period greater than or equal to 30 minutes and less than or equal to 360 minutes; and cooling the nucleated glass sheet to about room temperature by decreasing the temperature at a cooling rate greater than or equal to 1 °C/min and less than or equal to 5 °C/min, wherein the cooled nucleated glass sheet comprises a greater amount of lithium metasilicate than lithium disilicate.

Additional features and advantages of the methods of forming 3D shaped glass ceramics described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plot of temperature (y-axis) versus time (x-axis) of a ceramming process include a first nucleation phase and a second crystallization phase, according to one or more embodiments described herein;

FIG. 2 is a flowchart of a method for forming a 3D shaped glass ceramic, according to one or more embodiments described herein;

FIG. 3 is a flowchart of another method for forming a 3D shaped glass ceramic, according to one or more embodiments described herein;

FIG. 4 is a flowchart of another method for forming a 3D shaped glass ceramic, according to one or more embodiments described herein;

FIG. 5 is a graphical representation of a deviation from a computer-aided design (CAD) model, according to one or more embodiments described herein;

FIG. 6 is a photograph of 3D shaped glass ceramics formed using different pressure magnitudes during a molding step, according to one or more embodiments described herein;

FIG. 7 is a photograph of 3D shaped green glass article, according to one or more embodiments described herein;

FIG. 8 is a graphical representation of a deviation from a CAD model of the 3D shaped green glass article of FIG. 7;

FIG. 9 is a photograph of 3D shaped glass ceramic article, according to one or more embodiments described herein;

FIG. 10 is a graphical representation of a deviation from a CAD model of the 3D shaped glass ceramic article of FIG. 9;

FIG. 11 is a photograph of 3D shaped glass ceramic article, according to one or more embodiments described herein;

FIG. 12 is a graphical representation of a deviation from a CAD model of the 3D shaped glass ceramic article of FIG. 11;

FIG. 13 is a photograph of an opaque 3D shaped glass ceramic, according to one or more embodiments described herein;

FIG. 14 is a plot of haze (y-axis) versus nucleating temperature (Tn) (y-axis; in °C) of a 3D shaped glass ceramic, according to one or more embodiments described herein;

FIG. 15 is a plot of crystalline phase (y-axis; in wt %) versus nucleating temperature (Tn) (y-axis; in °C) of a 3D shaped glass ceramic, according to one or more embodiments described herein;

FIG. 16 is a plot of crystalline phase (y-axis; in wt %) versus nucleating temperature (Tn) (y-axis; in °C) of a 2D shaped nucleated glass article;

FIG. 17 is a plot of the ratio of lithium disilicate to petalite (y-axis) versus nucleating temperature (Tn) (y-axis; in °C) of a 2D shaped nucleated glass article; and

FIG. 18 is a plot of haze (y-axis) versus nucleating temperature (Tn) (y-axis; in °C) of a 2D shaped nucleated glass article.

### DETAILED DESCRIPTION

Reference will now be made in detail to various embodiments of methods of forming 3D shaped glass ceramics having desired mechanical and optical properties.

According to embodiments, a method of forming a 3D shaped glass ceramic includes nucleating a green glass article to form a nucleated glass article, the green glass article comprising a nucleating agent; sizing the nucleated glass article to form a preform; and molding the preform to shape and to crystallize the preform, thereby forming the 3D shaped glass ceramic.

According to embodiments, a method of forming a 3D shaped glass ceramic includes sizing a green glass article to form a preform having a desired dimension, the green glass article comprising a nucleating agent; and molding the preform to shape and to nucleate the preform, thereby forming a nucleated glass article.

According to embodiments, a method of forming a 3D shaped glass ceramic includes sizing a green glass article to form a preform having a desired dimension, the green glass article comprising a nucleating; and molding the preform to shape, to nucleate, and to crystallize the preform, thereby forming the 3D shaped glass ceramic.

According to embodiments, a nucleated glass sheet, the composition of which, at room temperature, includes: greater than or equal to 55 mol % and less than or equal to 80 mol % SiO₂; greater than or equal to 1 mol % and less than or equal to 14 mol % Al₂O₃; greater than or equal to 10 mol % and less than or equal to 35 mol % Li₂O; greater than or equal to 0 mol % and less than or equal to 12 mol % Na₂O; greater than or equal to 0 mol % and less than or equal to 12 mol % K₂O; greater than or equal to 0 mol % and less than or equal to 12 mol % CaO; greater than or equal to 0 mol % and less than or equal to 15 mol % P₂O₅; greater than or equal to 1 mol % and less than or equal to 15 mol % ZrO₂; greater than or equal to 0 mol % and less than or equal to 15 mol % Fe₂O₃; greater than or equal to 0 mol % and less than or equal to 15 mol % HfO₂; greater than or equal to 0 mol % and less than or equal to 15 mol % SnO₂; greater than or equal to 0 mol % and less than or equal to 10 mol % TiO₂; greater than or equal to 0 mol % and less than or equal to 10 mol % MgO; and a greater amount of lithium metasilicate than lithium disilicate.

According to embodiments, a nucleated glass sheet is formed by a process including: heating a green glass sheet to a nucleating temperature greater than or equal to 560 °C and less than or equal to 620 °C at a heating rate greater than or equal to 1 °C/min and less than or equal to 10 °C/min, the green glass sheet comprising a nucleating agent; maintaining the green glass sheet at the nucleating temperature for a time period greater than or equal to 30 minutes and less than or equal to 360 minutes; and cooling the nucleated glass sheet to about room temperature by decreasing the temperature at a cooling rate greater than or equal to 1 °C/min and less than or equal to 5 °C/min, wherein the cooled nucleated glass sheet comprises a greater amount of lithium metasilicate than lithium disilicate.

Various embodiments of methods of forming 3D shaped glass ceramics will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass composition and the resultant shaped glass ceramic described herein, the concentrations of constituent components (e.g., SiO₂, Al₂O₃, and the like) are specified in mole percent (mol %) on an oxide basis, unless otherwise specified. A total sum of concentrations of oxide components in the glass composition and the resultant shaped glass ceramic is equal to 100 mol %.

As used herein, “room temperature” refers to 25 °C.

As used herein, “about room temperature” refers to greater than or equal to 20 °C and less than or equal to 30 °C.

As described herein, temperatures, heating rates, and cooling rates refer to the temperature of the oven in which the article is being treated.

Various terms are used throughout the present disclosure to describe various states of the glass articles disclosed herein. As used herein, “green glass” refers to glass that has not been heat treated. “Nucleated glass” refers to glass that has been heat treated to a point where crystal nuclei are present but no, or substantially no, crystal growth has occurred and no, or substantially no, long range order exists on a crystal lattice. “Partially crystallized” refers to a glass article that has been heat treated to form a glass ceramic including crystalline phases(s) and a glassy phase; however, the final microstructure of the material has not been formed in terms of a desired phase assemblage, crystal morphology, and/or the corresponding target properties of the material are not met. “Fully crystallized” refers to a glass article that has been heat treated to form a glass ceramic including crystalline phase(s) and a glassy phase with the final microstructure of the material being formed in terms of the desired phase assemblage, crystal morphology, and/or the corresponding target properties of the material are met.

Alternatively or additionally, the various states of the glass articles disclosed herein can be defined using the phase assemblage of the material reported through Raman spectroscopy, for example. In such instances, “green glass” refers to a material composed of about 100%, or total, glass determined by Raman spectroscopy and/or x-ray diffraction analysis. “Nucleated glass” refers to a material composed of a greater amount of lithium metasilicate than lithium disilicate, indicating a greater presence of a precursor phase than a primary target phase. “Partially crystallized” refers to a glass article composed of a greater amount of lithium disilicate than lithium metasilicate; however, the article does not possess a desired mechanical property and/or a desired optical performance. “Fully crystallized” refers to a glass article composed of a greater amount of lithium disilicate than lithium metasilicate with a desired phase assemblage and target properties achieved.

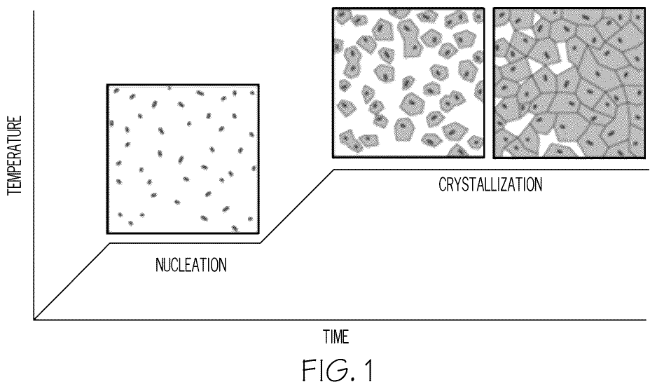

Machining of complex shapes can be cost prohibitive and/or can induce flaws that lower a mechanical standard, such as a strength, of a formed shape. More specifically, as shown in FIG. 1, a glass ceramic article is formed through a ceramming process. A first phase of the ceramming process includes nucleating a glass article having a nucleating agent.

After the glass article is nucleated, a second phase of the ceramming process occurs including exposing the nucleated glass article to an elevated temperature for crystallization (i.e., growth of crystals). As the nucleated glass article is exposed to a particular temperature for an extended period of time, a greater number and/or size of crystals form.

In various instances, once the second phase of crystallization is approximately 10% complete, for example, the glass ceramic article loses a particular viscosity, making it more difficult and/or unable to be formed into a three-dimensional (3D) shape. As such, forming, or otherwise shaping, a glass ceramic article may be easier when the original article is green glass, or partially crystallized glass. Precision requirements imposed on consumer electronic products typically have tolerances of approximately less than 100 μm. However, the use of such partially crystallized glass introduces an additional challenge, as meeting such tolerances may be difficult as volume changes occur within the article during ceramming. Moreover, the temperature required for nucleating and/or crystallizing the article exceeds a softening point of green glass, potentially inducing distortions into a formed shape. Additionally, utilization of a single mold for an extended period of time to produce a single formed glass ceramic article may be undesirable in instances where a large volume of glass ceramic articles are being manufactured.

Disclosed herein are methods of forming a 3D shaped glass ceramic which mitigate the aforementioned problems. Specifically, the various methods described herein may form a desired shape of three-dimensional (3D) shaped glass ceramics having a desired mechanical performance and/or a desired optical property.

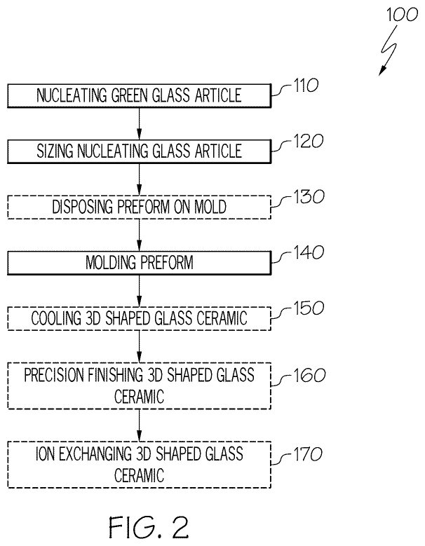

Referring now to FIG. 2, a method of forming a 3D shaped glass ceramic article is shown at 100. The method 100 begins at block 110 with nucleating a green glass article. Nucleating the green glass article to form a nucleated glass article prior to shaping the article into a desired shape may increase a longevity of a particular mold. For example, by nucleating the green glass article prior to shaping the article, the time the article ultimately remains positioned on the mold may decrease.

The green glass article may be defined by any suitable thickness, such as greater than or equal to 1.0 mm and less than or equal to 4.0 mm, greater than or equal to 1.0 mm and less than or equal to 3.0 mm, greater than or equal to 2.0 mm and less than or equal to 4.0 mm, greater than or equal to 3.0 mm and less than or equal to 4.0 mm, or any and all sub-ranges formed from any of these endpoints. Due to the changes that may occur during the formation of the 3D shaped glass ceramic, in embodiments, the green glass article may have a thickness less than or equal to 300 μm greater than a desired thickness of the 3D shaped glass ceramic. In embodiments, the green glass article may comprise a green glass sheet, a green glass substrate, and/or green glass in any suitable form.

The green glass article may comprise a nucleating agent, enabling the formation of the resultant 3D shaped glass ceramic. In embodiments, the nucleating agent may comprise P₂O₅, TiO₂, ZrO₂, or combinations thereof.

In embodiments, the green glass article and the resulting nucleated glass article may comprise a composition, at room temperature comprising greater than or equal to 55 mol % and less than or equal to 80 mol % SiO₂, greater than or equal to 1 mol % and less than or equal to 14 mol % Al₂O₃, greater than or equal to 10 mol % and less than or equal to 35 mol % Li₂O, greater than or equal to 0 mol % and less than or equal to 12 mol % Na₂O, greater than or equal to 0 mol % and less than or equal to 12 mol % K₂O, greater than or equal to 0 mol % and less than or equal to 12 mol % CaO, greater than or equal to 0 mol % and less than or equal to 15 mol % P₂O₅, greater than or equal to 1 mol % and less than or equal to 15 mol % ZrO₂, greater than or equal to 0 mol % and less than or equal to 15 mol % Fe₂O₃, greater than or equal to 0 mol % and less than or equal to 15 mol % HfO₂, greater than or equal to 0 mol % and less than or equal to 15 mol % SnO₂, greater than or equal to 0 mol % and less than or equal to 10 mol % TiO₂, and greater than or equal to 0 mol % and less than or equal to 10 mol % MgO.

In embodiments, the green glass article or the resulting nucleated glass article may comprise a composition at room temperature comprising greater than or equal to 60 mol % and less than or equal to 75 mol % SiO₂, greater than or equal to 1 mol % and less than or equal to 8 mol % Al₂O₃, greater than or equal to 15 mol % and less than or equal to 30 mol % Li₂O, greater than or equal to 0 mol % and less than or equal to 5 mol % Na₂O, greater than or equal to 0 mol % and less than or equal to 5 mol % K₂O, greater than or equal to 0 mol % and less than or equal to 5 mol % CaO, greater than or equal to 0 mol % and less than or equal to 7 mol % P₂O₅, greater than or equal to 1 mol % and less than or equal to 7 mol % ZrO₂, greater than or equal to 0 mol % and less than or equal to 5 mol % Fe₂O₃, greater than or equal to 0 mol % and less than or equal to 5 mol % HfO₂, greater than or equal to 0 mol % and less than or equal to 5 mol % SnO₂, greater than or equal to 0. mol % and less than or equal to 5 mol % TiO₂, and greater than or equal to 0 mol % and less than or equal to 5 mol % MgO.

In embodiments, the green glass article or the resulting nucleated glass article may comprise a composition at room temperature comprising greater than or equal to 65 mol % and less than or equal to 75 mol % SiO₂, greater than or equal to 2 mol % and less than or equal to 6 mol % Al₂O₃, greater than or equal to 18 mol % and less than or equal to 28 mol % Li₂O, greater than or equal to 0 mol % and less than or equal to 1 mol % Na₂O, greater than or equal to 0 mol % and less than or equal to 1 mol % K₂O, greater than or equal to 0 mol % and less than or equal to 3 mol % CaO, greater than or equal to 0.5 mol % and less than or equal to 3 mol % P₂O₅, greater than or equal to 1 mol % and less than or equal to 5 mol % ZrO₂, greater than or equal to 0 mol % and less than or equal to 1 mol % Fe₂O₃, greater than or equal to 0 mol % and less than or equal to 1 mol % HfO₂, greater than or equal to 0 mol % and less than or equal to 1 mol % SnO₂, greater than or equal to 0. mol % and less than or equal to 1 mol % TiO₂, and greater than or equal to 0 mol % and less than or equal to 1 mol % MgO.

Nucleating the green glass article may comprise heating the green glass article to a nucleating temperature. In embodiments, the nucleating temperature may be greater than or equal to 560 °C and less than or equal to 620 °C, greater than or equal to 560 °C and less than or equal to 600 °C, greater than or equal to 580 °C and less than or equal to 620 °C, or even greater than or equal to 580 °C and less than or equal to 600 °C, or any and all sub-ranges formed from any of these endpoints. In embodiments, the green glass article may be heated to the nucleating temperature at a heating rate greater than or equal to 1 °C/min and less than or equal to 10 °C/min, greater than or equal to 1 °C/min and less than or equal to 8 °C/min, greater than or equal to 1 °C/min and less than or equal to 6 °C/min, greater than or equal to 3 °C/min and less than or equal to 10 °C/min, greater than or equal to 3 °C/min and less than or equal to 8 °C/min, greater than or equal to 3 °C/min and less than or equal to 6 °C/min, greater than or equal to 5 °C/min to less than or equal to 10 °C/min, greater than or equal to 5 °C/min to less than or equal to 8 °C/min, or even greater than or equal to 5 °C/min and less than or equal to 6 °C/min, or any and all sub-ranges formed from any of these endpoints.

Once the green glass article is heated to the nucleating temperature, the nucleating temperature may be held, or otherwise maintained, at the nucleating temperature for a particular time period. In embodiments, the nucleating temperature hold time period may be greater than or equal to 30 minutes and less than or equal to 360 minutes, greater than or equal to 30 minutes and less than or equal to 300 minutes, greater than or equal to 30 minutes and less than or equal to 240 minutes, greater than or equal to 30 minutes and less than or equal to 180 minutes, greater than or equal to 30 minutes and less than or equal to 120 minutes, greater than or equal to 60 minutes and less than or equal to 360 minutes, greater than or equal to 60 minutes and less than or equal to 300 minutes, greater than or equal to 60 minutes and less than or equal to 240 minutes, greater than or equal to 60 minutes and less than or equal to 180 minutes, or even greater than or equal to 60 minutes and less than or equal to 120 minutes, or any and all sub-ranges formed from any of these endpoints.

The nucleated glass article may then be cooled to about room temperature by decreasing the temperature of the nucleated glass article at a cooling rate of greater than or equal to 1 °C/min and less than or equal to 5 °C/min. As described herein, the temperatures, heating rates, and cooling rates provided herein refer to the temperature of the oven in which the green article is being nucleated.

Referring back to FIG. 2, the method 100 continues at block 120 with sizing the nucleated green glass article to form a preform. The resultant preform is defined by any desirable dimensions, such as a particular length, width, and/or thickness. The nucleated green glass article can be sized to such desirable dimension(s) through any suitable process, such as by cutting, for example.

Referring back to FIG. 2, the method 100 may optionally continue at block 130 with disposing the preform on a mold. The mold may support the formed shape as the 3D shaped glass is being crystallized. The mold may be made of a material that maintains uniform heat transfer to the preform. Such a material can include, for example, silicone carbide, graphite, and/or any suitable material that is highly-thermally conductive and is non-reactive with glass. Should the preform not be positioned on a mold as the 3D shaped glass ceramic is being formed and/or if the mold is not made of a suitable material, the preform and/or the resulting 3D shaped glass ceramic may become misshapened and/or warped. Due to the mold maintaining uniform heat transfer to the preform, in embodiments, the preform may be at least partially crystallized during the disposing the preform on the mold.

Referring back to FIG. 2, the method 100 continues at block 140 with molding the preform to shape and to crystalize the preform, thereby forming the 3D shaped glass ceramic. As the preform is being shaped, the preform is being crystallized. At such point, nucleation may continue and/or crystal growth may occur. In various instances, the preform can be shaped and crystallized simultaneously. In other instances, the shaping and crystallization can occur in different phases, for example.

In embodiments, the molding the preform may comprise applying a pressure to the preform and heating the preform at a molding temperature. In embodiments, the mold may apply a force or a pressure onto the preform such that the preform is shaped into a desired shape, such as a 3D shape. Such a force application may additionally promote a faster rate of crystallization than would occur under atmospheric pressure, for example. The mold can further apply, or otherwise expose, the preform to a molding temperature to aid in the crystallization process.

In embodiments, the pressure may be greater than or equal to 0.001 MPa and less than or equal to 1.0 MPa, greater than or equal to 0.001 MPa and less than or equal to 0.9 MPa, greater than or equal to 0.001 MPa and less than or equal to 0.7 MPa, greater than or equal to 0.001 MPa and less than or equal to 0.5 MPa, greater than or equal to 0.01 MPa and less than or equal to 1.0 MPa, greater than or equal to 0.01 MPa and less than or equal to 0.9 MPa, greater than or equal to 0.01 MPa and less than or equal to 0.7 MPa, greater than or equal to 0.01 MPa and less than or equal to 0.5 MPa, greater than or equal to 0.001 MPa and less than or equal to 1.0 MPa, greater than or equal to 0.1 MPa and less than or equal to 0.9 MPa, greater than or equal to 0.1 MPa and less than or equal to 0.7 MPa, greater than or equal to 0.1 MPa and less than or equal to 0.5 MPa, greater than or equal to 0.25 MPa and less than or equal to 1.0 MPa, greater than or equal to 0.25 MPa and less than or equal to 0.9 MPa, greater than or equal to 0.25 MPa and less than or equal to 0.7 MPa, greater than or equal to 0.25 MPa and less than or equal to 0.5 MPa, greater than or equal to 0.5 MPa and less than or equal to 1.0 MPa, greater than or equal to 0.5 MPa and less than or equal to 0.9 MPa, or even greater than or equal to 0.5 MPa and less than or equal to 0.7 MPa, or any and all sub-ranges formed from any of these endpoints.

In embodiments, the molding temperature may be greater than or equal to 700 °C and less than or equal to 900 °C, greater than or equal to 700 °C and less than or equal to 860 °C, greater than or equal to 700 °C and less than or equal to 820 °C, greater than or equal to 750 °C and less than or equal to 900 °C, greater than or equal to 750 °C and less than or equal to 860 °C, greater than or equal to 750 °C and less than or equal to 820 °C, greater than or equal to 800 °C and less than or equal to 900 °C, greater than or equal to 800 °C and less than or equal to 860 °C, or even greater than or equal to 800 °C and less than or equal to 820 °C, or any and all sub-ranges formed from any of these endpoints. In embodiments, the molding temperature may be less than or equal to 820 °C. In embodiments, the molding temperature may be less than or equal to 900 °C.

In embodiments, different pressures may be applied to the preform and/or the preform may be heated at different molding temperatures over the duration of the molding at block 140. For example, a first pressure may be applied to the preform for a first time duration and a second pressure may be applied to the preform for a second time duration. In embodiments, the first time duration may be different than the second time duration. For example, the first time duration may be shorter than the second time duration or the first time duration may be longer than the second time duration. Moreover, the first pressure may be greater or less than the second pressure. In embodiments, the preform may be heated at a first molding temperature for a third time duration to facilitate nucleation of the preform, for example. The preform may then be heated at a second, different molding temperature for a fourth time duration to facilitate crystallizing of the preform, for example. In such embodiments, the first temperature may be less than the second temperature. In other embodiments, the first temperature may be greater than the second temperature. In embodiments, the third time duration may be different than the fourth time duration. For example, the third time duration may be shorter than the fourth time duration or the third time duration may longer than the fourth time duration. In other instances, the third time duration may be the same as the fourth time duration.

In embodiments, the 3D shaped glass ceramic may comprise various crystalline phases, such as lithium disilicate, lithium metasilicate, petalite, or combinations thereof. In embodiments, the 3D shaped glass ceramic comprises a greater amount of lithium metasilicate than lithium disilicate.

In embodiments, the 3D shaped glass ceramic may be visually transparent or opaque. An opaque glass ceramic may be desirable for various design features, such as for use as an enclosure for a back side of a device, for example. The opaque nature of the 3D glass ceramic may provide increased mechanical properties, such as a higher fracture toughness, for example.

Referring back to FIG. 2, the method 100 may optionally continue at block 150 with cooling the 3D shaped glass ceramic. The 3D shaped glass ceramic may be cooled to minimize a residual stress, for example. The 3D glass ceramic may be cooled to about room temperature by decreasing the temperature of 3D glass ceramic at a cooling rate of greater than or equal to 1 °C/min and less than or equal to 5 °C/min.

Referring back to FIG. 2, the method 100 may optionally continue at block 160 with precision finishing the 3D shaped glass ceramic. In embodiments, the precision finishing of the 3D shaped glass ceramic may comprise at least one of polishing the 3D shaped glass ceramic and machining the 3D shaped glass ceramic using a Computer Numerical Control (CNC) machining technique,

The type and/or extent of the precision finishing to achieve a desired result may be dependent on the type and/or extent of sizing that was used to form the preform in block 120. For example, in embodiments where only an edge of the preform was sized to achieve a particular length and/or width, a CNC machining technique may be used, for example, to achieve a desired thickness. The method 200 may then include polishing the 3D shaped glass ceramic to obtain optimal surface quality and remove any surface imperfections and/or marks.

In embodiments where a more involved preform sizing occurred at block 120 to size the preform to a desired thickness, for example, the 3D shaped glass ceramic may be polished to obtain optimal surface quality and remove any surface imperfections and/or marks, for example. As such, sizing the article into a preform having a desired thickness prior to molding the article may result in less material being removed from the 3D shaped glass ceramic such that the CNC machining may not be used. However, application of the CNC machining technique can optionally still occur.

Referring back to FIG. 2, the method may optionally continue at block 170 with ion exchanging the 3D shaped glass ceramic. In typical ion exchange processes, smaller metal ions in the glass substrate are replaced or “exchanged” with larger metal ions of the same valence within a layer that is close to the outer surface of the ceramic. The replacement of smaller ions with larger ions creates a compressive stress within the layer of the multi-colored glass substrate. In embodiments, the metal ions are monovalent metal ions (e.g., Li⁺, Na⁺, K⁺, and the like), and ion exchange is accomplished by immersing the ceramic in a bath comprising at least one molten salt of the larger metal ion that is to replace the smaller metal ion in the ceramic. Alternatively, other monovalent ions such as Ag⁺, Tl⁺, Cu⁺, and the like may be exchanged for monovalent ions. The ion exchange process or processes that are used to strengthen the ceramic may include contacting the ceramic with an ion-exchange medium. In embodiments, the ion-exchange medium may be a molten salt bath. For example, the ion exchange process may include, but is not limited to, immersion in a single bath or multiple baths of like or different compositions with optional washing and/or annealing steps between immersions.

Upon exposure to the ceramic, the ion exchange solution (e.g., KNO₃ and/or NaNO₃ molten salt bath) may, according to embodiments, be at a temperature greater than or equal to 350 °C and less than or equal to 500 °C, greater than or equal to 360 °C and less than or equal to 450 °C, greater than or equal to 370 °C and less than or equal to 440 °C, greater than or equal to 360 °C and less than or equal to 420 °C, greater than or equal to 370 °C and less than or equal to 400 °C, greater than or equal to 375 °C and less than or equal to 475 °C, greater than or equal to 400 °C and less than or equal to 500 °C, greater than or equal to 410 °C and less than or equal to 490 °C, greater than or equal to 420 °C and less than or equal to 480 °C, greater than or equal to 430 °C and less than or equal to 470 °C, or even greater than or equal to 440 °C and less than or equal to 460 °C, or any and all sub-ranges between the foregoing values. In embodiments, the ceramic may be exposed to the ion exchange solution for a duration greater than or equal to 2 hours and less than or equal to 24 hours, greater than or equal to 2 hours and less than or equal to 12 hours, greater than or equal to 2 hours and less than or equal to 6 hours, greater than or equal to 8 hours and less than or equal to 24 hours, greater than or equal to 6 hours and less than or equal to 24 hours, greater than or equal to 6 hours and less than or equal to 12 hours, greater than or equal to 8 hours and less than or equal to 24 hours, or even greater than or equal to 8 hours and less than or equal to 12 hours, or any and all sub-ranges formed from any of these endpoints.

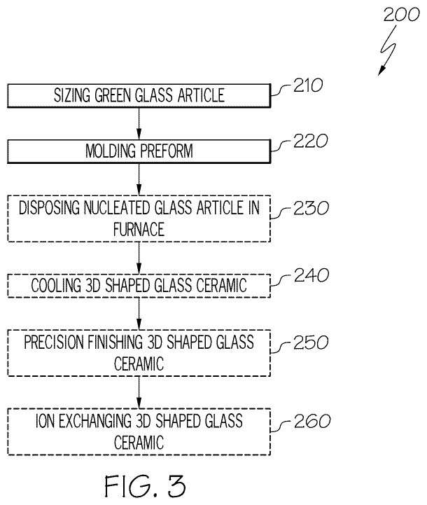

Referring now to FIG. 3, another method of forming a 3D shaped glass ceramic is shown at 200. The steps, materials, components, and parameters of method 200 may be the same as or similar to the steps, materials, components, and parameters as described with respect to method 100 of FIG. 2, unless otherwise noted. The method 200 may begin at block 210 with sizing a green glass article to form a preform having a desired dimension. The green glass article may comprise a nucleating agent.

Referring back to FIG. 3, the method 200 may continue at block 220 with molding the preform to shape and to nucleate the preform, thereby forming a nucleated glass article. In embodiments, the preform shaping and nucleating occur simultaneously. In other embodiments, shaping and nucleation occur consecutively. In embodiments, during the molding the preform, the preform may be fully or partially crystallized.

Referring again to FIG. 3, the method 200 may optionally continue at block 230 with disposing the nucleated article in a furnace to crystallize the nucleated glass article, thereby forming a 3D shaped glass ceramic. In embodiments, the nucleated glass article is disposed, placed, or otherwise positioned, in a furnace, such as a ceram furnace. The disposing the nucleated glass article in the furnace may comprise applying a pressure to the nucleated glass article. In embodiments, the disposing the nucleated glass article in the furnace may comprise disposing the 3D shaped glass ceramic on a mold such that a shape of the 3D shaped glass ceramic is maintained as the pressure is applied.

Referring back to FIG. 3, the method 200 may optionally continue at block 240 with cooling the 3D shaped glass ceramic, at block 250 with precision finishing the 3D shaped glass ceramic, and/or at block 260 with ion exchanging the 3D shaped glass ceramic.

Referring now to FIG. 4, another method of forming a 3D shaped glass ceramic is shown at 300. The steps, materials, components, and parameters of method 300 may be the same as or similar to the steps, materials, components, and parameters of method 300 as described with respect to method 100 of FIG. 2, unless otherwise noted. The method 300 may begin at block 310 with sizing a sizing a green glass article to form a preform having a desired dimension. The green glass article may comprise a nucleating agent.

Referring back to FIG. 4, the method 300 may continue at block 220 with molding the preform to shape, to nucleate, and to crystallize the preform, thereby forming the 2D shaped glass ceramic. In embodiments, the preform shaping, nucleation, and crystallization occur simultaneously. In other embodiments, shaping, nucleation, and crystallization occur consecutively. In embodiments, during the molding the preform, the preform may be fully or partially crystallized.

The molding the preform may include disposing the preform in a furnace. In embodiments, the preform is disposed, placed, or otherwise positioned, in a furnace, such as a ceram furnace. The disposing the preform in the furnace may comprise applying a pressure to the preform. In embodiments, the disposing the preform in the furnace may comprise disposing the preform on a mold such that a shape of the resulting 3D shaped glass ceramic is maintained as the pressure is applied.

Referring back to FIG. 4, the method 300 may optionally continue at block 330 with cooling the 3D shaped glass ceramic, at block 340 with precision finishing the 3D shaped glass ceramic, and/or at block 340 with ion exchanging the 3D shaped glass ceramic.

### EXAMPLES

In order that various embodiments be more readily understood, reference is made to the following examples, which illustrate various embodiments of forming a 3D shaped glass ceramic described herein.

An article comprising example glass composition E1, shown in Table 1 below, having a thickness of 1.5 mm was nucleated for 2.8 hours at 585 °C. The nucleated glass was cooled to about room temperature from 585 °C and was then placed on a graphite mold. Once on the graphite mold, the nucleated glass was heated to a maximum temperature of 820 °C. The nucleated glass was held at 820 °C for 300 seconds with 0.9 MPa of pressure applied thereto. The nucleated glass was then cooled while maintaining the same application of 0.9 MPa of pressure thereto in an initial stage of cooling. The total cycle to 3D shaped glass ceramic from the nucleated glass article involved 0.75 hour of heating from about room temperature and cooling back to about room temperature. The resulting 3D shaped glass ceramic had the crystal phase assemblage shown in Table 2 by weight percent and visually was optically clear.

TABLE 1

| (mol %) | E1 |
|---|---|
| SiO₂ | 68.98 |
| Al₂O₃ | 4.03 |
| Li₂O | 22.3 |
| Na₂O | 0.06 |
| K₂O | 0.07 |
| CaO | 0.71 |
| P₂O₅ | 1.01 |
| ZrO₂ | 2.78 |
| Fe₂O₃ | 0.02 |
| HfO₂ | 0.03 |
| SnO₂ | 0.01 |
| Total | 100.00 |

TABLE 2

| Glass | Li₂Si₂O₅ | Petalite | Li₂SiO₃ |
|---|---|---|---|
| 15-17% | 42-44% | 39-41% | 0-<2% |

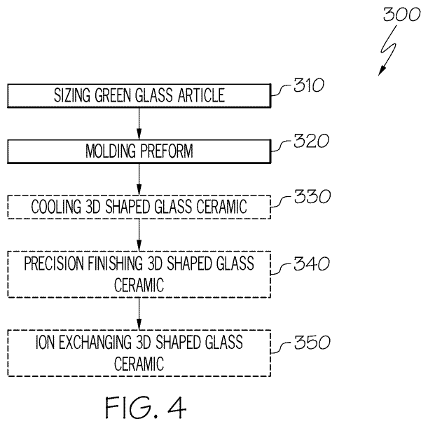

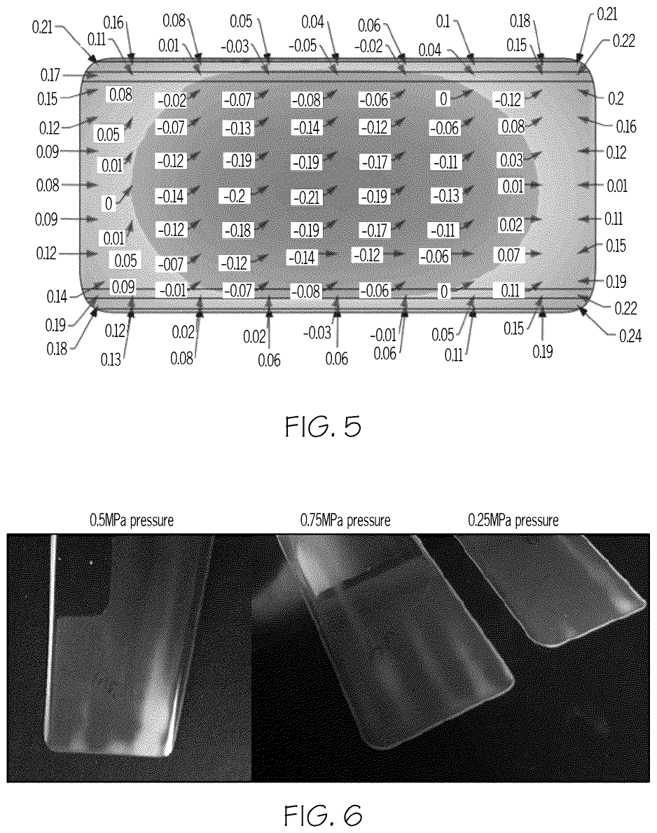

FIG. 5 depicts a graphical representation of a deviation, measured in millimeters (mm), from a computer-aided design (CAD) model and a green glass article that was nucleated along with shaping during a molding process, for example. As can be seen, minimal deviation, or warping, was present. The article was molded at a molding temperature ranging from 800-820 °C for a duration of 250-350 seconds.

FIG. 6 depicts the impact that the pressure applied to an article during a molding step has on optical clarity of the formed article. The green glass article was nucleated prior to the molding step, such as in methods 100 and 200 described herein. Application of a relatively low pressure during the molding, and crystallizing, may yield a formed ceramic with an undesirable crystal structure.

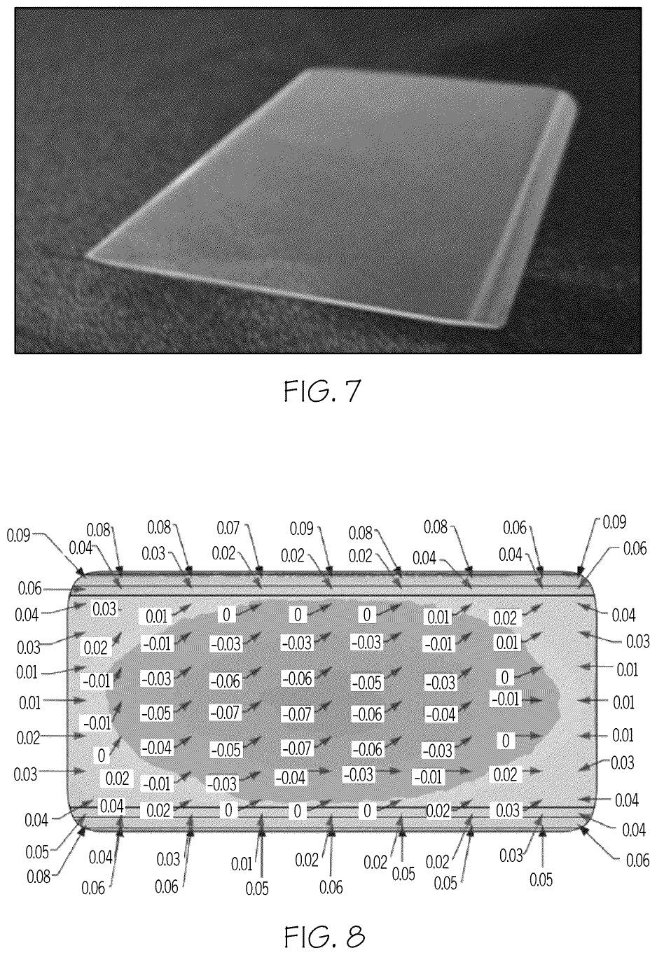

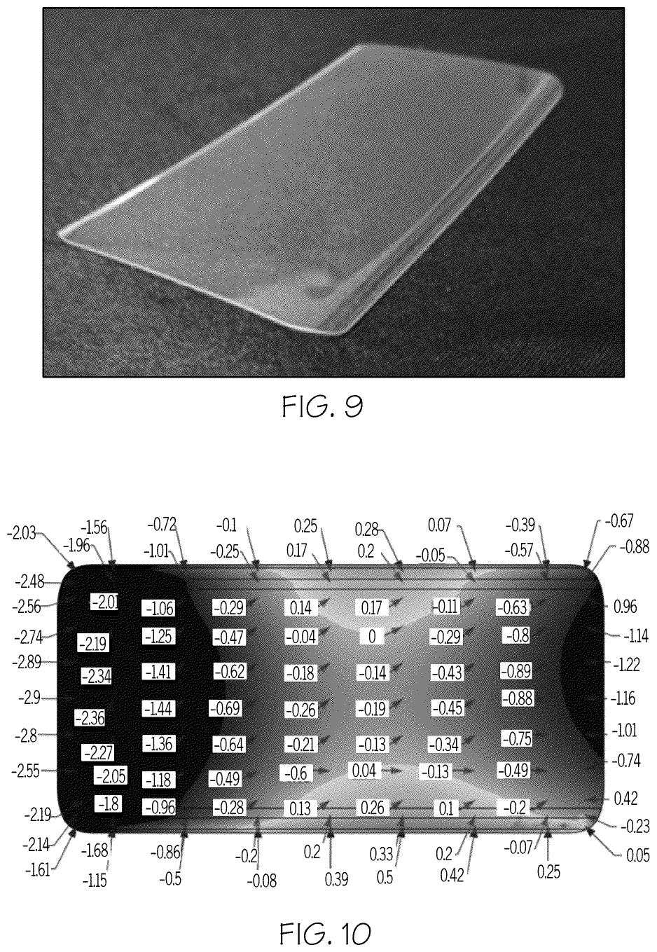

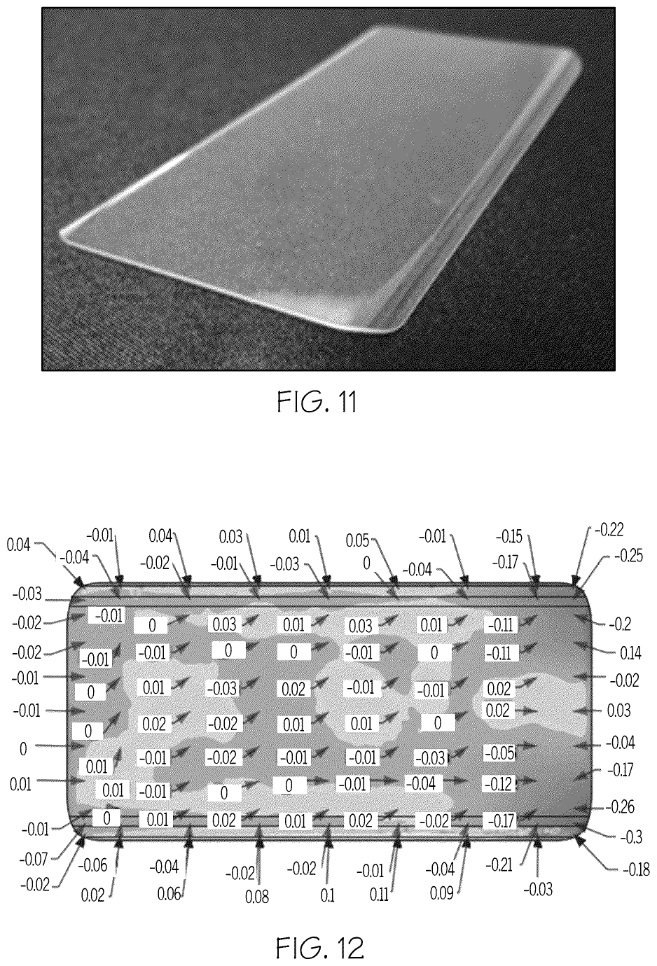

Referring now to FIGS. 7-12, the effect of applying a pressure during forming is shown. Specifically, referring to FIGS. 7 and 8, there was relatively little deviation and/or warping of the 3D shaped green glass article. Referring to FIGS. 9 and 10, a 3D shaped glass ceramic was at least partially crystallized in a furnace without application of a pressure. The lack of pressure resulted in a relatively significant deviation from the CAD model. Referring now to FIGS. 11 and 12, a 3D shaped glass ceramic was at least partially crystallized in a furnace with application of pressure. The application of pressure to the article resulted in minimal, or insignificant, deviation from the CAD model visualized by a smooth, non-warped 3D shaped glass ceramic.

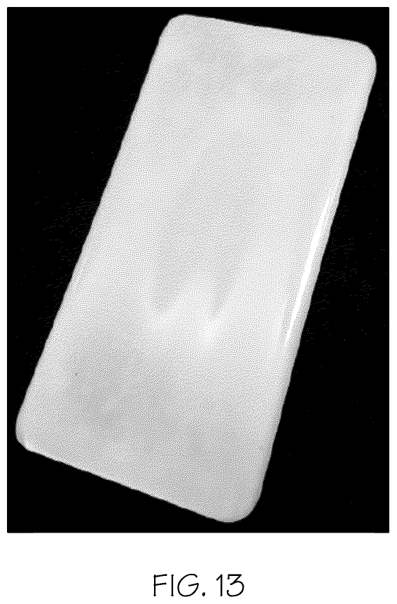

FIG. 13 shows a 3D shaped opaque glass ceramic formed by a method involving nucleating and ceramming a green glass article during a 3D molding process.

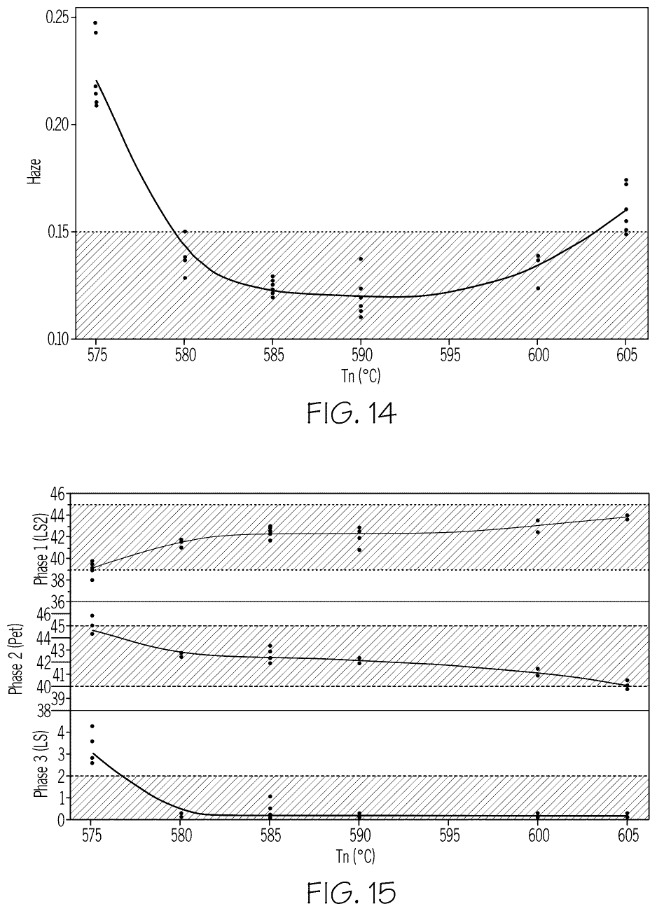

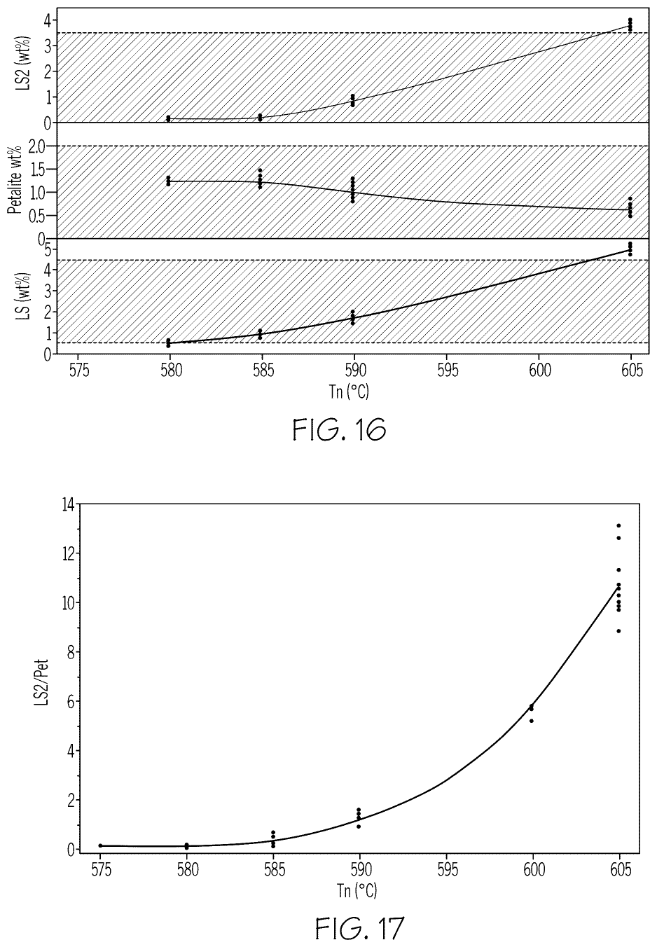

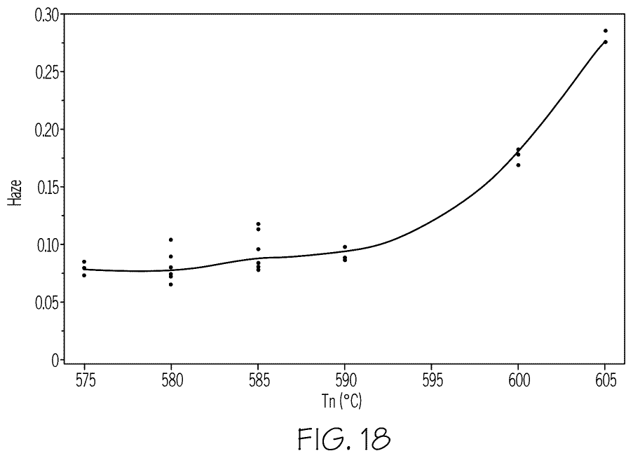

Referring now to FIGS. 14-18, haze and crystalline phases resulting from various nucleation temperature (Tn (°)) are shown. Referring now to FIGS. 14 and 15, a 2D green glass article was subjected to nucleation and then subjected to shaping and nucleation to form a 3D glass ceramic. Referring now to FIGS. 16-18, a 2D green glass article was subjected to nucleation. Referring now to Table 3, the resulting ranges for the amount of various crystalline phases and haze by subjecting articles to various nucleation temperatures are shown.

TABLE 3

| | | | 2D nucleation | |
|---|---|---|---|---|
| | | | and 3D | |
| Phase | Unit | 2D ceram | crystallization | 2D nucleation |
| lithium disilicate (LS2) | wt % | 40-48 | 39-46 | 0-3.5 |
| petalite (Pet) | wt % | 39-45 | 40-45 | 0-2 |
| lithium silicate (LS) | wt % | 0-2 | 0-2 | 0.5-4.5 |
| LS2/Pet | — | — | — | <7 |
| Haze | % | <0.15 at 0.55 mm | <0.15 at 0.55 mm | <0.20 at 1.5 mm |

As exemplified by FIGS. 5-18, the various methods described herein may form a desired shape of three-dimensional (3D) shaped glass ceramics having a desired mechanical performance and/or a desired optical property.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of forming a 3D shaped glass ceramic, the method comprising:
nucleating a green glass article to form a nucleated glass article, the green glass article comprising a nucleating agent;
sizing the nucleated glass article to form a preform; and
molding the preform to shape and to crystallize the preform, thereby forming the 3D shaped glass ceramic.

2. The method of claim 1, wherein the nucleating agent comprises P₂O₅, TiO₂, ZrO₂, or combinations thereof.

3. The method of claim 1, wherein the nucleating the green glass article comprises heating the green glass article to a nucleating temperature greater than or equal to 560 °C and less than or equal to 620 °C and holding at the nucleating temperature for a nucleating temperature hold time period greater than or equal to 30 minutes and less than or equal to 360 minutes.

4. The method of claim 1, wherein the molding the preform comprises:
applying a pressure to the preform; and
heating the preform at a molding temperature.

5. The method of claim 4, wherein the pressure is greater than or equal to 0.001 MPa and less than or equal to 1.0 MPa.

6. The method of claim 4, wherein the molding temperature is greater than or equal to 700 °C and less than or equal to 900 °C.

7. The method of claim 1, further comprising:
disposing the preform on a mold prior to the molding the preform, wherein the preform is at least partially crystallized during the disposing the preform on the mold.

8. The method of claim 1, wherein the nucleating the green glass article comprises nucleating the green glass article in a furnace.

9. The method of claim 1, further comprising:
cooling the 3D shaped glass ceramic.

10. A method of forming a 3D shaped glass ceramic, the method comprising:
sizing a green glass article to form a preform having a desired dimension, the green glass article comprising a nucleating agent; and
molding the preform to shape and to nucleate the preform, thereby forming a nucleated glass article.

11. The method of claim 10, wherein during the molding the preform, the preform is at least partially crystallized.

12. The method of claim 10, further comprising:
disposing the nucleated glass article in a furnace to crystallize the nucleated glass article, thereby forming the 3D shaped glass ceramic.

13. The method of claim 12, wherein the disposing the nucleated glass article in the furnace comprises applying a pressure to the nucleated glass article.

14. The method of claim 13, wherein the disposing the nucleated glass article in the furnace comprises disposing the nucleated glass article on a mold such that a shape of the 3D shaped glass ceramic is maintained as the pressure is applied.

15. The method of claim 10, wherein the molding the preform comprises applying a pressure to the preform greater than or equal to 0.001 MPa and less than or equal to 1.0 MPa.

16. The method of claim 10, wherein the molding the preform comprises heating the preform to a molding temperature, wherein the molding temperature is less than or equal to 900 °C.

17. A method of forming a 3D shaped glass ceramic, the method comprising:
sizing a green glass article to form a preform having a desired dimension, the green glass article comprising a nucleating; and
molding the preform to shape, to nucleate, and to crystallize the preform, thereby forming the 3D shaped glass ceramic.

18. The method of claim 17, wherein the molding the preform comprises applying a pressure greater than or equal to 0.001 MPa and less than or equal to 1.0 MPa to the preform.

19. The method of claim 17, wherein the molding the preform comprises heating the preform to a molding temperature.

20. The method of claim 19, wherein the molding temperature is less than or equal to 900 °C.
